(19) United States
(12) Patent Application Publication
(10) Pub. No.: US 2006/0149679 A1
(43) Pub. Date: Jul. 6, 2006

(54) Privilege management system, method, and recording medium

(75) Inventors: Hidekazu Nishizawa, Tokyo (JP); Junichi Yamamoto, Tokyo (JP); Shinko Riku, Tokyo (JP); Masataka Yamada, Tokyo (JP); Naoto Akimoto, Tokyo (JP); Shinichi Matsukawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/540,267

(22) PCT Filed: Dec. 25, 2003
(86) PCT No.: PCT/JP03/16765

§ 371 Date: Nov. 3, 2005

(30) Foreign Application Priority Data
Dec. 25, 2002 (JP) 2002374715

(51) Int. Cl. G06Q 99/00

(52) U.S. Cl. 705/51

(57) ABSTRACT

In the example of the invention, an accepting section of a privilege management system accepts privilege coupon data and a right data acquisition request. The privilege coupon data includes permitting side condition ID which specifies a utilization permitting side which permits granting a privilege. The acquisition request includes a utilizing side ID indicative of a right data utilizing side. The verifying section determines that the privilege is granted to the requesting side when the permitting side condition ID is consistent with the utilizing side ID. The service section grants the privilege to the requesting side when it is determined that the privilege is granted.

### TECHNICAL FIELD

The present invention relates to a privilege management system, method, and a recording medium in a content distribution system which distributes a digital content (which will be referred to as “content” hereinafter) such as electronic book data, music data, moving picture data and others.

### BACKGROUND ART

In recent years, with the development of an information-intensive society, there has been widely utilized a content distribution system which distributes a digital content obtained by computerizing a book or newspaper to a user terminal so that the content can be viewed.

In particular, a content distribution system which separately distributes an encrypted content (which will be referred to as “encrypted content” hereinafter) and a decryption key thereof has been utilized.

It is to be noted that a description will be given provided that the encrypted content is also one type of the content.

In the content distribution system, many proprietors or individuals concern the distribution of the content.

Distribution participators concerning the distribution of the content include, e.g., a content provider (corresponding to a publisher) who creates and provides the content, a content circulator (corresponding to a book seller) who circulates the content, a key manager who manages and distributes a decryption key, a charging personnel who collects and distributes sales proceeds, a user who utilizes the content, and others.

Roles as the content provider, the content circulator, the key manager and the charging personnel may be undertaken by different persons in some cases and, on the other hand, the same person may play a plurality of roles in some cases.

A content circulator may be an individual rather than a proprietor in some cases. In order to facilitate the distribution of contents, it is important to pay values appropriate to various kinds of distribution participators mentioned above.

In regard to the content distribution system which distributes the content and the decryption key, some charging and sales proceeds distribution methods have been already proposed.

For example, Patent Reference 1 (Jpn. Pat. Appln. KOKAI Publication No. 9-73487) and Patent Reference 2 (Jpn. Pat. Appln. KOKAI Publication No. 2002-133147) disclose techniques which distribute sales proceeds among the content provider and other affiliated enterprises.

In a content distribution system disclosed in Patent Reference 3 (Jpn. Pat. Appln. KOKAI Publication No. 2001-5877), the content provider and the content circulator respectively register desired amounts of money in a system of the charging personnel. The content provider and the content circulator respectively register desired amounts of money in the system of the charging personnel. The system of the charging personnel determines a sales fee in accordance with each amount of money, and distributes the sales fee to the content provider and the content circulator.

Patent Reference 4 (Jpn. Pat. Appln. KOKAI Publication No. 2002-41993) discloses a technique which records a fee or store information in a charge settlement server when the user requests a system of the key manager for the decryption key.

Patent Reference 5 (Jpn. Pat. Appln. KOKAI Publication No. 2002-229960) discloses a technique which records a distribution path of the content when copying the content between user terminals which utilize the content, and performs issue of a key or charging in accordance with the distribution path data.

Patent Reference 6 (Jpn. Pat. Appln. KOKAI Publication No. 9-73480) discloses a system which changes a content sales price in accordance with a content sales time.

In content distribution system which separately distributes the encrypted content and the decryption key, a system which determines a sales fee to be collected from the user and distributes the sales proceeds between the content provider and the content circulator has already existed.

In cases where the content is distributed to the user with a fee by a content provider, a content circulator and the key manager, the content provider and the content circulator request the charging personnel who performs charge management to realize various services such as a discount. For example, when contents are regularly purchased or the user who belongs to a given group purchases the content, the content provider or the content circulator requests the charging personnel to realize a discount service.

However, in an existing content distribution system in which the content provider, the content circulator and the key manager concern the circulation, how a privilege is granted is not concretely considered at all.

Further, an existing system to which the above-described techniques are applied has a problem of insufficient flexibility when granting the privilege to the user.

For example, as privileges granted to the user, “a given content provider or content circulator provides a discount service to a user who has applied for continuation of purchasing decryption keys for contents which are periodically issued” or “a given content provider or content circulator makes a discount on a fee when a decryption key is issued to a user who belongs to a given group”.

However, in the existing system, when granting a privilege to the user, a system of the content provider, a system of a content circulator, a system of the key manager, a system of the charging personnel, settings and software must be changed in accordance with a content of this privilege.

Furthermore, the content provider or the content circulator must inform a person who is in charge of a privilege service, e.g., the charging personnel of the detailed content of a privilege to be granted. Moreover, the person who is in charge of a privilege service must correctly grasp a content of this privilege and change a system, settings and software.

A privilege service which should be provided by the content provider or the content circulator has many variations, and frequently changes. However, in the existing system, it is hard for the content provider or the content circulator to rapidly and easily carry out and change the privilege service.

In actual transactions, a service which makes a discount on a fee with respect to a customer who has a discount coupon is widely performed. In actual transactions, only one discount coupon can be used each time as a general rule.

However, when trying to simply electronically realize a privilege service using a discount coupon, there is a problem that discount coupon data corresponding to the discount coupon is copied and anyone can enjoy the discount service again and again. Therefore, even if the discount coupon is simply computerized, it is difficult to appropriately provide the user with a privilege intended by a content provider or a content circulator.

### DISCLOSURE OF INVENTION

In the example of the invention, a privilege management system comprises an accepting section which accepts privilege coupon data indicative of a content of a privilege and a condition under which the privilege is granted, and a right data acquisition request including data which is used to judge whether the privilege is granted, from a requesting side of right data which releases a utilization restriction of a circulation content, a verifying section which judges whether the privilege is granted to the requesting side based on the privilege coupon data and the acquisition request, and a service section which grants the privilege to the requesting side based on the content of the privilege indicated by the privilege coupon data when it is determined that the privilege is granted. The privilege coupon data includes a permitting side condition ID which specifies a utilization permitting side which permits granting the privilege. The acquisition request includes a utilizing side ID indicative of a right data utilizing side. The verifying section determines that the privilege is granted to the requesting side when the permitting side condition ID is consistent with the utilizing side ID.

### BRIEF DESCRIPTION OF DRAWINGS

FIG. 1 is a block diagram showing an example of a general configuration of a content distribution system according to the first embodiment of the invention.

FIG. 2 is a block diagram showing an example of exchange of a decryption key and discount coupon data in a content distribution system according to the first embodiment.

FIG. 3 is a block diagram showing an example of a management system according to the first embodiment.

FIG. 4 is a class diagram showing an example of a logic data configuration of discount coupon data.

FIG. 5 is a flowchart showing an example of processing of a discount coupon management section of a management system.

FIG. 6 is a flowchart showing an example of processing of a key distributing section of a management system.

FIG. 7 is a class diagram showing an example of discount data according to the second embodiment of the invention.

FIG. 8 is a class diagram showing an example of an acquisition request set according to the second embodiment.

FIG. 9 is a class diagram showing an example of discount data according to the third embodiment of the invention.

FIG. 10 is a class diagram showing an example of discount data according to the fourth embodiment of the invention.

FIG. 11 is a class diagram showing an example of discount coupon data according to the fifth embodiment of the invention.

FIG. 12 is a class diagram showing an example of an acquisition request set according to the fifth embodiment.

FIG. 13 is a class diagram showing an example of discount coupon data according to the sixth embodiment of the invention.

FIG. 14 is a class diagram showing an example of discount coupon data according to the seventh embodiment of the invention.

### BEST MODE FOR CARRYING OUT THE INVENTION

Embodiments according to the present invention will now be described hereinafter with reference to the accompanying drawings.

In each drawing, like reference numerals denote like parts in order to eliminate a description or give a brief description of these parts, and a detailed description will be given on different parts only.

In each embodiment, a management system which flexibly and easily grants a privilege in the content distribution will be described.

### First Embodiment

In this embodiment, it is assumed that a content to be distributed is encrypted in order to restrict utilization.

Right data which is used to release the utilization restriction of an encrypted content is a decryption key.

It is to be noted that any other utilization restriction technique and right data may be used in this embodiment. For example, the content may be restricted from being used by a password. In this case, right data is a password.

In this embodiment, a description will be given as to an example where a discount is made on a fee as a privilege. In this embodiment, a discount coupon system is introduced with respect to an encrypted pay content. A technique described in this embodiment can be likewise applied to a case in which other privileges than a discount on a fee, e.g., giving a service point are granted.

Discount coupon data according to this embodiment is one type of privilege coupon data, and it can be freely copied and transferred after once issued and can be utilized by arbitrary users.

A discount condition required to get a discount service is defined in a discount coupon data in advance, and the discount condition can be recognized from the discount coupon data. A user must meet the discount condition in order to get a discount service.

For example, A content as a discount target, a circulation path of a content with which a discount is permitted, a decryption key utilizing side which is allowed for a discount (a user, a user terminal or the like which utilizes a decryption key) and others are specified as the discount condition.

Combining the discount conditions can provide a requesting side which has requested the decryption key (the user, the user terminal or the like which has requested the decryption key) with various privilege services.

The decryption key utilizing side is identified by a utilizing side ID. As the utilizing side ID, specifically, a user ID or the like which is indicative of a user or a user terminal which uses the decryption key is utilized.

In this embodiment, although the description will be given on the assumption that the utilizing side or the requesting side is the user, this can be also applied to, e.g., the user terminal.

FIG. 1 is a block diagram showing an example of a general configuration of a content distribution system according to this embodiment.

A content provider 1 runs a content provision system 2. A content circulator 3 runs a content circulation system 4. A user 5 operates a user terminal 6. A key manager 7 runs a management system 8.

In this embodiment, although a description will be given as to an example where the key manager 7 also serves as a charging personnel, the key manager 7 may be different from the charging personnel.

When the key manager 7 is different from the charging personnel, the key manager 7 runs a part which manages the decryption key in the management system 8, and the charging personnel runs a part which manages charging in the management system 8.

The content provider 1 and the content circulator 3 may be the same person. The user terminal 6 may acquire an encrypted content through the plurality of content circulation systems 4.

The content provision system 2 encrypts a content created by the content provider 1 and provides the encrypted content to the content circulation system 4.

The content circulation system 4 provides the user terminal 6 with the encrypted content.

The user terminal 6 provides the management system 8 with a request for acquiring the decryption key which is required to decrypt the encrypted content and discount coupon data concerning the decryption key for the encrypted content, and accepts the decryption key as a response.

A content of a discount and a discount condition which is used to judge whether a discount is allowed are defined in the discount coupon data.

Various kinds of data, e.g., a content ID which identifies a content (which may be an encrypted content ID which identifies the encrypted content), a path ID, a user ID and others are arbitrarily selected in accordance with a content of a discount service and included in a decryption key acquisition request.

The user terminal 6 may provide an acquisition request set in which a plurality of acquisition requests are organized to the management system 8 in some cases.

The management system 8 comprises a communicating function 9 which transmits/receives various kinds of data and requests to/from the user terminal 6.

Further, the management system 8 comprises a discount coupon verifying function 10 which judges whether an acquisition request from the user terminal 6 satisfies the discount condition defined in the discount coupon data.

Furthermore, the management system 8 comprises a service function 11 which executes a discount service in accordance with the detail of a discount defined in the discount coupon data when the discount condition is satisfied.

It is to be noted that various methods are applied to a content encryption method and a decryption key generation method. For example, the content provision system 2 may ask the management system 8 for encryption. The management system 8 may generate and record a decryption key in accordance with a request for encryption of a content.

Moreover, a method of settling a fee from the user 5 who has accepted the decryption key to a predetermined person and a method of distributing profits can be freely set. For example, settlement in which a fee is collected from the user 5 by the key manager 7 and distributed to the content provider 1 and the content circulator 3 may be performed in the management system 8.

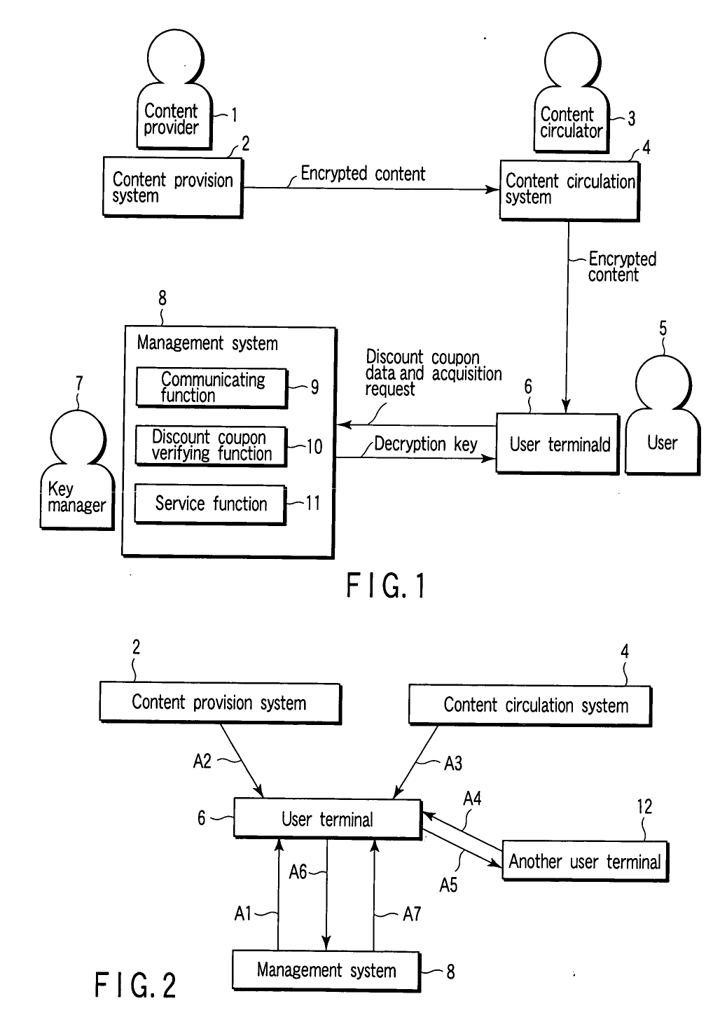

FIG. 2 is a block diagram showing an example of exchange of the decryption key and discount coupon data in the content distribution system according to this embodiment.

The user terminal 6 accepts the discount coupon data from one of the management system 8, the content provision system 2, the content circulator system 4 and another user terminal 12 (A1 to A4).

It is to be noted that the user terminal 6 may copy the accepted discount coupon data and provides it to another user terminal 12 (A5).

The user terminal 6 provides a decryption key acquisition request and the discount coupon data to the management system 8 (A6).

The management system 8 verifies the decryption key acquisition request and the detail of the discount coupon data, provides the decryption key to the user 5, and makes a discount on a fee if the discount condition is satisfied (A7). It is to be noted that the management system 8 may provide the user terminal 6 with another discount coupon data together with the decryption key.

It is to be noted that a discount coupon data distribution method and issue method can be freely set. For example, the discount coupon data may be attached to the encrypted content provided to the user terminal 6 from the content circulation system 4.

Additionally, the user terminal 6 may download the discount coupon data from a site of the content provider 1 or the content circulator 3, the content provision system 2, the content circulation system 4 and others.

Further, the discount coupon data may be recorded in a recording medium such as a CD-ROM attached to a magazine, and the user terminal 6 may read and use the discount coupon data from this recording medium.

The discount coupon data may be available with or without a fee depending on discount services. A discount condition which allows a specific user alone to utilize the discount coupon data may be set in pay discount coupon data.

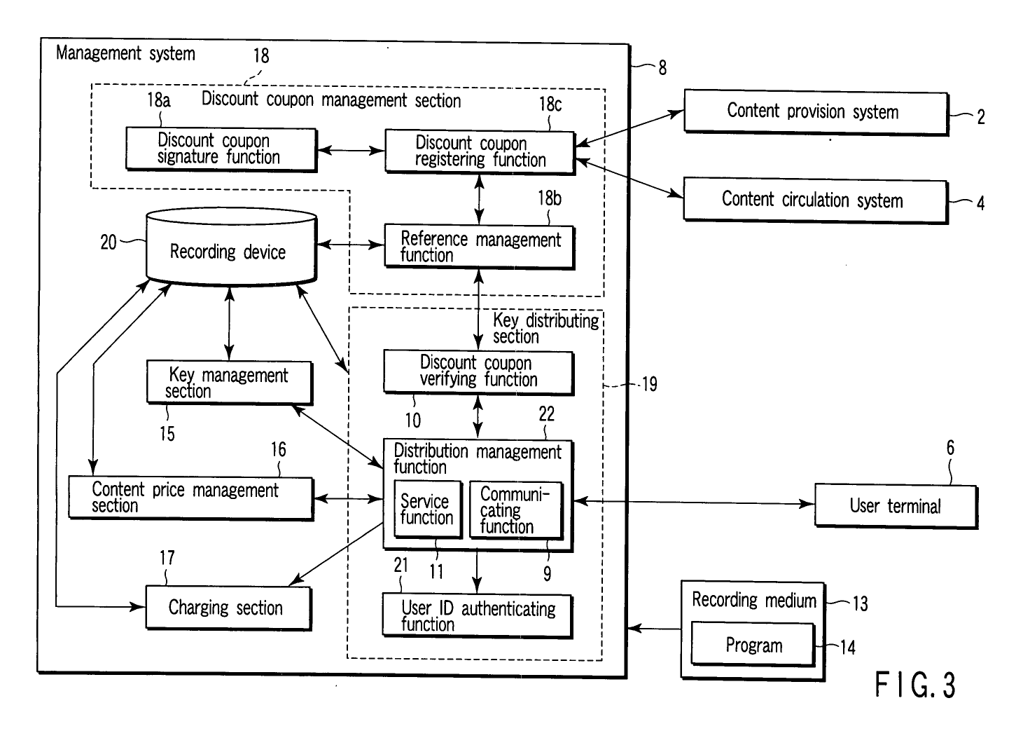

FIG. 3 is a block diagram showing an example of the management system 8 according to this embodiment.

The management system 8 reads and executes a program 14 recorded in a recording medium 13 to realize functions as a key management section 15, a content price management section 16, a charging section 17, a discount coupon management section 18 and a key distributing section 19.

Furthermore, the management system 8 comprises a recording device 20. For example, a memory, a hard disk or the like is used for this recording device 20. For example, a database or the like may be used in place of the recording device 20. The recording device 20 may be externally provided with respect to the management system 8.

It is to be noted that, although not shown in FIG. 3, the management system 8 may also comprise various elements such as a content encrypting section which accepts the content from the content provision system 2 to create the encrypted content, various attribute management section and others.

The key management section 15 manages a decryption key which decrypts a predetermined encrypted content, and reads the decryption key recorded in the recording device 20 as required.

The contents price management section 16 manages data indicative of a regular fee (a price, a rate) of the decryption key recorded in the recording device 20, and reads a regular fee from the recording device 20 as required.

The charging section 17 performs charging with respect to the user, and records a charging result in the recording device 20.

The discount coupon management section 18 comprises a discount coupon signature function 18a, a reference management function 18b and a discount coupon registering function 18c.

The discount coupon registering function 18c accepts discount coupon data including a discount amount and a discount condition from the content provision system 2 or the content circulation system 4, and specification of all or part of the discount coupon data recorded in the recording device 20.

The discount coupon registering function 18c provides all or part of the specified discount coupon data to the reference management function 18b, and accepts a reference ID which is required to make reference to all or part of the discount coupon data recorded in the recording device 20 as a response.

The discount coupon registering function 18c returns the reference ID to the content provision system 2 or the content circulation system 4 or write the reference ID at a predetermined position in the discount coupon data, provides the discount coupon data with the reference ID written therein to the discount coupon signature function 18a, accepts discount coupon data subjected to preprocessing which is required to detect interpolation as a response, and returns the preprocessed discount coupon data to the content provision system 2 or the content circulation system 4.

The discount coupon signature function 18a accepts the discount coupon data defined by the content provider 1 or the content circulator 3 and updated with the reference ID in accordance with specification from the discount coupon registering function 18c, and attaches a signature to this data, and returns the data with the signature to the discount coupon registering function 18c. Attachment of the signature by this discount coupon signature function 18a may be performed by an arbitrary method. For example, an electronic signature is used. Furthermore, the discount coupon data may be simply encrypted in place of the electronic signature. Besides, various kinds of methods which detect or prevent interpolation by a person other than the key manager 7 can be applied in place of the electronic signature.

The reference management function 18b accepts from the discount coupon registering function 18c all or part of the discount coupon data specified to be recorded in the recording device 20 in the defined discount coupon data, records the accepted data in the recording device 20, issues a reference ID of all or part of the recorded discount coupon data, and returns the reference ID to the discount coupon registering function 18c.

Moreover, the reference management function 18b reads all or part of the discount coupon data from the recording device 20 based on the reference ID accepted from the discount coupon verification function 10, and returns all or part of the read discount coupon data to the discount coupon verifying function 10.

The key distributing section 19 comprises a distribution management function 22, a user ID authenticating function 21 and a discount coupon verifying function 10.

The distribution management function 22 accepts a decryption key acquisition request and the discount coupon data from the user terminal 6 operated by the user 5, and returns the decryption key in cooperation with other various constituent elements. Additionally, the distribution management function 22 reads necessary data from the recording device 20, and records the necessary data in the recording device 20.

The distribution management function 22 comprises a communicating function 9 and a service function 11.

The communicating function 9 accepts a decryption key acquisition request and the discount coupon data from the user terminal 6, records the acquisition request and the discount coupon data in the recording device 20, accepts the requested decryption key from the key management section 15, and returns the decryption key to the user terminal 6.

The service function 11 requests the user ID authenticating function 21 to authenticate a user or a user terminal based on a user ID.

Additionally, the service function 11 provides discount coupon data and an acquisition request to the discount coupon verifying function 10, and accepts a discount amount determined value as a response.

Further, the service function 11 accepts a regular fee from the content price management section 16, subtracts the discount amount determined value accepted from the discount coupon verifying function 10 from the regular fee, and provides a disconnected fee to the charging section 17.

The user ID authenticating function 21 authenticates a user or a user terminal based on a user ID in response to an authentication request from the service function 11.

The discount coupon verifying function 10 accepts the discount coupon data and the acquisition request from the service function 11.

The discount coupon verifying function 10 detects interpolation of the discount coupon data, and judges whether the discount coupon data is proper data without interpolation.

For example, when an electronic signature is used in the discount coupon signature function 18a, the discount coupon verifying function 10 confirms this electronic signature.

Furthermore, for example, in cases where the discount coupon data is encrypted with a secret key of this discount coupon signature function 18a by the discount coupon signature function 18a, the discount coupon verifying function 10 determines that the discount coupon data is valid when the discount coupon data can be decrypted by an open key.

For detection and prevention of interpolation of the discount coupon data, any other scheme may be used in the discount coupon signature function 18a and the discount coupon verifying function 10.

The discount coupon verifying function 10 returns zero as a discount amount determined value if interpolation is made to the discount coupon data.

When a reference ID is included in the discount coupon data, the discount coupon verifying function 10 provides the reference ID to the reference management function 18b, accepts data indicated by the reference ID as a response, and recognizes the entire content of the discount coupon data.

The discount coupon verifying function 10 judges whether a discount is allowed based on the entire content of the recognized discount coupon data and the content of data which is included in the acquisition request and used to judge whether a discount is made.

Further, the discount coupon verifying function 10 returns a discount amount indicated by the discount coupon data as a discount amount determined value to the distribution management function 22 when a discount is allowed, and returns zero as a discount amount determined value when a discount is not allowed.

It is to be noted that the discount coupon verifying function 10 may perform verification for preventing a person who does not concern issue of the discount coupon data from unjustly obtaining profits based on a distribution rule of the discount coupon data.

For example, unjustly making a discount on a fee paid to the content circulator 3 by using discount coupon data issued by the content provider 1 is prohibited.

The discount coupon data will now be described.

The discount coupon data is data distributed on a network, and includes a discount amount and a discount condition.

Furthermore, the discount coupon data may include a link (a reference ID) to all or part of data indicative of a discount amount and a discount condition. The management system 8 verifies the discount coupon data to see if there is any interpolation.

The discount coupon data can be freely copied and used, and can be freely transferred between users or user terminals.

Therefore, a discount condition which allows a discount must be clearly defined in the discount coupon data.

For example, if the discount condition which restrict a user or user terminal to which a discount is allowed is defined, a specific user or user terminal alone can get a discount service even if this discount coupon data is copied.

As discount conditions, there are a discount condition which specify a user or user terminal, a discount condition which specifies a content ID, a discount condition which specifies a circulation path of a content, and any other conditions.

A user or a user terminal can receive a discount service by using the discount coupon data any number of times as long as the discount conditions are satisfied.

The consistency of individual discount conditions defined in the discount coupon data and data included in an acquisition request is sequentially verified by the discount coupon verifying function 10.

Moreover, if all discount conditions are satisfied, a discount amount of the discount coupon data is returned as a discount amount determined value to the service function 11 from the discount coupon verifying function 10.

On the other hand, if conditions are not satisfied or the discount coupon data is interpolated, zero is returned as a discount mount determined value to the service function 11 from the discount coupon verifying function 10.

In the discount coupon data, for example, conditions that a user or a user terminal has a specific user ID or belongs to a specific user group are defined.

The definition of a user group, i.e., relationship data indicating which user belongs to which user group may be written in the discount coupon data, or may be recorded in the recording device 20 of the management system 8.

Additionally, in the discount coupon data, conditions that a content has a specific content ID or belong to a specific series (which may be a content group) are defined.

Relationship data which is the definition of a series and indicates which a content belongs to which series may be written in the discount coupon data, or may be recorded in the recording device 20 of the management system 8.

In order to define that a content belongs to a specific series, a series ID as well as a content ID may be associated with the content.

For example, in regard to a periodical publication, a common series ID is given to contents issued in different months.

Moreover, in the discount coupon data, for example, a condition that a circulation path of an encrypted content has a specific path ID or belongs to a specific path group is defined.

The definition of a specific path group, i.e., relationship data indicating which circulation path belongs to which circulation group may be written in the discount coupon data, or may be recorded in the recording device 20 of the management system 8.

As other discount conditions, a time condition which allows utilization within a predetermined period, before a predetermined date and hour or after a predetermined date and hour may be defined.

Additionally, as other discount conditions, a distribution rule which distributes profits in accordance with a predetermined profit distribution rule when a discount is made may be defined.

One set of discount coupon data may be applied to an acquisition request set including a plurality of decryption key acquisition requests.

In this case, as a discount condition, the number of decryption keys which must be purchased at minimum or the number of decryption keys which can be purchased at maximum may be defined as the discount condition.

The discount service may be performed with respect to each decryption key fee or a sum of fees for a plurality of decryption keys if a scheme is determined in advance.

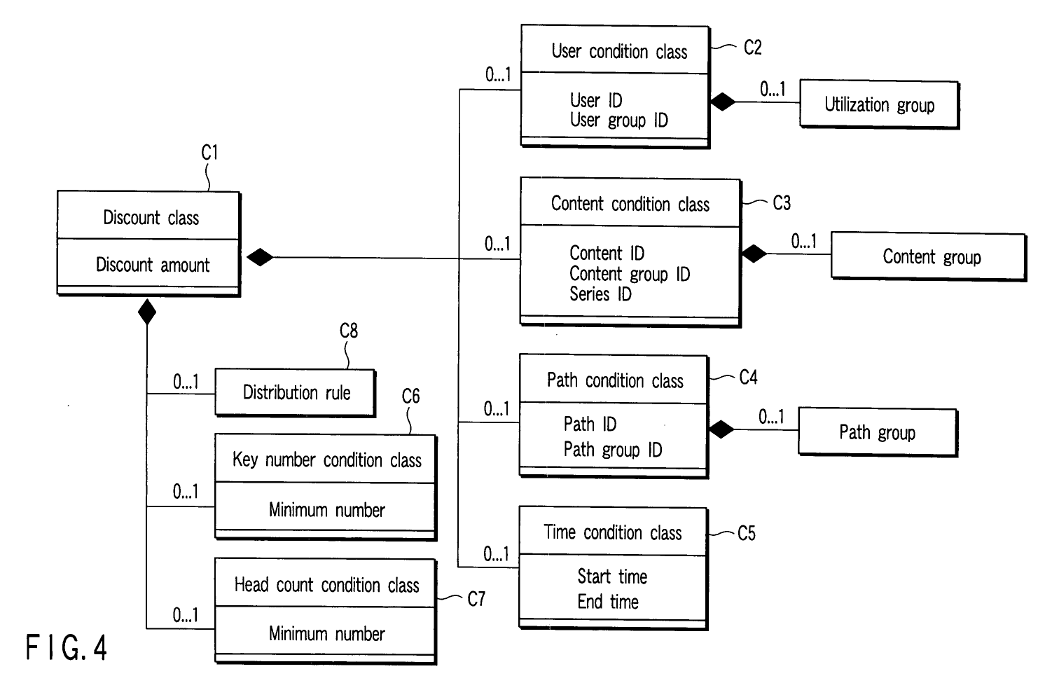

FIG. 4 is a class diagram showing an example of a logic data configuration of the discount coupon data. It is to be noted that an actual format and expression method of the discount coupon data is not restricted to FIG. 4 and can be freely changed.

The discount coupon data is represented as a discount class. The discount class has a discount amount which is a content of a privilege as an attribute (a discount attribute).

Further, a discount class C1 has a user condition class C2, a content condition class C3, a path condition class C4, a time condition class C5, a key number condition class C6 and a head count condition class C7 as attributes.

Each attribute may be eliminated depending on properties of a discount service. Furthermore, the discount class C1 has a distribution rule C8 as an attribute.

The user condition class C2 has one or more user IDs with which a discount is permitted.

A user ID is a code which can specify a user or a user terminal.

It is to be noted that a description will be given on an example where a user ID specifies a user in each of the following embodiments, but it can be likewise applied to an example where a user ID specifies a user terminal.

When the number of user to which a discount is allowed is one, a user ID attribute is defined in the user condition class C2, and other attributes are blank.

When a discount is allowed to a plurality of users, user IDs of the plurality of users are defined as a user group ID in the user condition class C2.

It is to be noted that the user group ID may be represented as an array of the user IDs.

Moreover, a plurality of user IDs may be recorded in the recording device 20 of the management system 8, and this user group ID may be determined as a reference ID which is used to make reference to the plurality of recorded user IDs.

The content condition class C3 has one or more content IDs with which a discount is allowed. The content ID is a code which can an uniquely specify content.

When a discount is allowed to a single set of content, a content ID attribute is defined in the content condition class C3, and other attributes are blank.

When a discount is allowed to a plurality of sets of contents, a plurality of content IDs are defined as a content group ID in the content condition class C3.

It is to be noted that a content group ID may be represented as an array of a plurality of content IDs. Further, a plurality of content IDs may be recorded in the recording device 20 of the management system 8, and a content group ID may be a reference ID which is used to make reference to the plurality of content group IDs.

Furthermore, in the content condition class C3, a series ID indicative of a series of content to which a discount is allowed may be defined.

A series ID is a code which can uniquely specify a series of content.

For example, respective contents of a series such as periodical publications are represented by a common series ID. When a series ID is defined in the content condition class C3 in this manner, a period in which a discount is allowed may be defined in the time condition class C5.

In the path condition class C4, a condition which is required to allow a discount when an encrypted content is acquired through a specific circulation path is defined.

A path ID is a code which identifies a content circulator or a circulation channel.

When a discount is allowed with respect to a single circulation path only, a path ID attribute is defined and other attributes are blank in the path condition class C4.

When a discount is allowed with respect to a plurality of circulation paths, in the path condition class C4, a plurality of path IDs are defined as a path group ID.

It is to be noted that the path group ID may be represented by an array of path IDs. Further, a plurality of path IDs may be recorded in the recording device 20 of the management system 8, and a path group ID may be a reference ID which is used to make reference to the plurality of recorded path IDs.

In the time condition class C5, a period in which a discount is allowed is defined.

In the time condition class C5, one or both of a start time attribute and an end time attribute are defined.

For example, in the time condition class C5 are defined conditions under which a discount is allowed until a given end time, a discount is allowed from a given start time, a discount is allowed from a given start time to a given end time, or a discount is not allowed from a given end time to a given start time.

In the key number condition class C6, a condition required to allow a discount when a plurality of decryption keys are acquired is defined.

A minimum number attribute indicates the number of decryption keys which must be acquired at minimum in order to allow a discount.

In the head count condition class C7, a condition which are required to allow a discount when a decryption key is used by a plurality of users is defined.

A minimum head count attribute indicates the minimum number of people who must purchase as a group.

It is to be noted that a condition required to allow a discount when a decryption key is used by a plurality of user terminals may be defined in place of the condition required to allow a discount when a decryption key is used by a plurality of users.

In the distribution rule C8, a distribution rule of a fee paid by a user is defined. A distribution rule can be freely defined by an arbitrary technique.

As described above, it is to be noted that a discount amount in the discount class C1, or all or part of the details of the respective condition classes C2 to C7 and the distribution rule C8 may be recorded in the recording device 20 of the management system 8 in some cases.

For example, it is assumed that the condition classes C3 to C7 and the distribution data C8 except the user condition class C2 are recorded in the recording device 20 and the discount class C1 has the user condition class C2 and a reference ID for any other classes as attributes.

In this case, data other than the user condition class C2 in a plurality of types of discount coupon data can reuse the content of the recording device 20.

Other configurations can be freely applied to the condition classes of the discount coupon data by defining formats in advance.

The key distributing section 19 may process the discount coupon data having a condition other than the condition classes shown in FIG. 4 being defined. In this case, it is good enough to add an algorithm which verifies a condition of an added parameter to the discount coupon verifying function 10.

An operation of the management system 8 according to this embodiment will now be described.

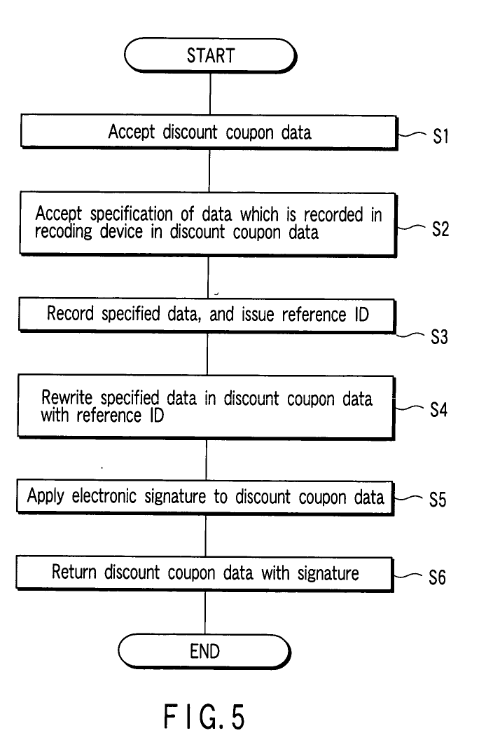

FIG. 5 is a flowchart showing an example of processing of the discount coupon management section 18 of the management system 8.

At a step S1, the discount coupon registering function 18c accepts the discount coupon data from the content provision system 2 or the content circulation system 4.

At a step S2, the discount coupon registering function 18c accepts specification of data in the discount coupon data which is recorded in the recording device 20 from the content provision system 2 or the content circulation system 4.

At a step S3, the reference management function 18b records the specified data in the recording device 20, and issues a reference ID which is used to make reference to this specified data.

At a step S4, the discount coupon registering function 18c rewrites the specified data in the discount coupon data with the reference ID, and requests the discount coupon signature function 18a to perform a signature.

At a step S5, the discount coupon signature function 18a attaches a signature to the discount coupon data in which the specified data is rewritten with the reference ID and returns this discount coupon data in response to the request from the discount coupon registering function 18c.

At a step S6, the discount coupon registering function 18c returns the discount coupon data with the signature to the content provision system 2 or the content circulation system 4.

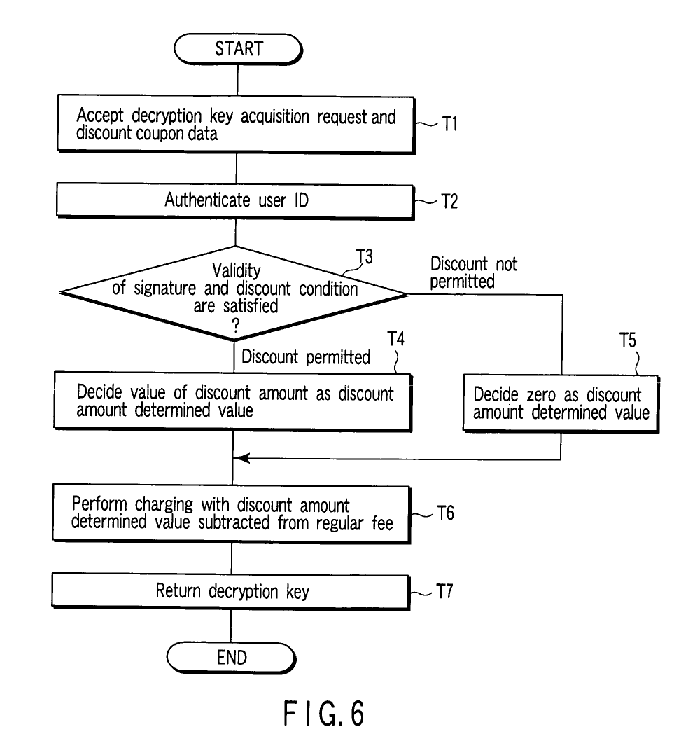

FIG. 6 is a flowchart showing an example of processing of the key distributing section 19 of the management system 8.

At a step T1, the communicating function 9 of the distribution management function 22 accepts a acquisition request of a decryption key and the discount coupon data from the user terminal 6.

It is to be noted that the communicating function 9 may accept an acquisition request set in which a plurality of acquisition requests are put together.

For example, when performing group purchasing or periodic purchasing, a plurality of acquisition requests are collected to generate an acquisition request set.

For example, the acquisition request includes a user ID of a user who uses the decryption key, a contents ID, a path ID and others.

A user ID included in the acquisition request may not be a user ID of a user who requests the decryption key or a user terminal itself.

When the acquisition request includes a user ID with which a decryption key is used or a user ID, the decryption key can be acquired as a present.

At a step T2, the user ID authenticating function 21 authenticates the user ID included in the acquisition request.

At a step T3, the discount coupon verifying function 10 verifies a signature of the discount coupon data based on the discount coupon data and a purchase request.

Moreover, the discount coupon verifying function 10 acquires necessary condition classes from the reference management function 18b to constitute data of the complete discount class, sequentially verifies the condition classes defined in the data of the discount class, and judges whether the acquisition request satisfies the discount condition.

For example, whether the discount condition is satisfied is judged by comparing the decryption key acquisition request with the parameter of the condition class.

If the signature is proper and the discount condition is satisfied, the discount coupon verifying function 10 returns a value of a discount amount of the discount class as a discount amount determined value to the service function 11 of the distribution management function 22 at a step T4.

If the signature is improper or the discount condition is not satisfied, the discount coupon verifying function 10 returns zero as a discount amount determined value to the service function 11 of the distribution management function 22 at a step T5.

At a step T6, the service function 11 accepts a regular fee corresponding to the content ID included in the acquisition request from the content price management section 16, and charges an amount obtained by subtracting the discount amount determined value from the regular fee.

It is to be noted that, if a plurality of regular fees are accepted, the discount determined value is subtracted from a sum of the plurality of regular fees to carry out charging, for example.

At a step T7, the communicating function 9 of the distribution management function 22 accepts the decryption key corresponding to the content ID included in the decryption key acquisition request from the key management section 15, and returns this decryption key to the user terminal 6.

In the above-described processing, the step T7 may be executed any time after the step T2.

In this embodiment, the content provider 1 or the content circulator 3 who wants to carry out a discount service can grant a privilege to a predetermined user by just writing and issuing discount coupon data corresponding to a discount service which should be provided, and easily and rapidly carry out his/her own discount service.

Additionally, since a person who wants to carry out a discount service does not have to inform any other person who is in charge of the discount service of the detail of a content of the discount service if he/she writes the discount coupon data, the discount service can be readily and rapidly carried out.

Further, in this embodiment, the key manager 7 who has a role as the charging personnel checks the discount condition which is defined in the discount coupon data and provides the management system 8 with the discount coupon management section 18 and the key distributing section 19 which perform a discount when an acquisition request satisfies the discount condition, and hence he/she does not have to change/add his/her own system, change/add settings, or change/add software even if a new discount service is carried out or a discount service is changed.

Therefore, it is possible to flexibly cope with various discount services and flexibly deal with changes in discount services.

Furthermore, in this embodiment, although the discount coupon data can be copied, the user who use the discount coupon data or the number of times of utilization can be restricted by judging the consistency of an acquisition request and the discount coupon data, thereby realizing a service complying with an intension of a person who carries out a discount service.

It is to be noted that each function of the management system 8 is realized by the program 14 in this embodiment, it may be realized by hardware.

Moreover, the arrangement of the respective constituent elements provided in the contents distribution system according to this embodiment may be changed if the same operations can be realized, or the respective constituent elements may be freely combined with each other, or the respective constituent elements may be freely separated from each other.

Additionally, each of the various systems 2, 4 and 8 described in conjunction with this embodiment comprises a plurality of computers, and functions of the various systems 2, 4 and 8 may be distributed and arranged in a plurality of computers so that processing can be executed in cooperation with each other.

Further, the program 14 according to this embodiment can be written in the recording medium 13 such as a magnetic disk (a flexible disk, a hard disk or the like), an optical disk (a CD-ROM, a DVD or the like) or a semiconductor memory and applied to a computer. Furthermore, the program 14 can be transmitted through a communication medium to be applied to a computer. The computer reads the program 14 so that operations are controlled by the program, thereby realizing the above-described functions.

### Second Embodiment

In this embodiment, a description will be given as to a method of realizing a discount service by the content distribution system explained in conjunction with the first embodiment when periodically purchasing a plurality of sets of contents.

A decryption key purchase price may differ depending on each circulation path until a user acquires an encrypted content. For example, a given content circulator makes a discount with respect to a user who periodically purchases contents, but another content circulator does not make a discount in some cases.

In case of periodically purchasing a plurality of sets of contents, a conformation of a service or a specification of a condition varies depending on whether encrypted contents are acquired through the same predetermined circulation path or whether a content acquisition path is selected each time.

Moreover, a conformation of a service or a specification of a condition varies depending on whether a decryption key is acquired from the management system 8 every time contents are periodically issued or whether respective decryption keys of a plurality of sets of contents to be issued are purchased in bulk.

In this embodiment, a description will be given as to setting of conditions of the discount coupon data when a plurality of sets of encrypted contents which are periodically issued from the same circulation path are acquired and respective decryption keys of the respective sets of encrypted contents are acquired in bulk.

In this embodiment, the user 5 previously obtains discount coupon data in which a series ID is defined in the content condition class, a path ID is defined in the path condition class and the minimum number is defined in the key number condition class.

On the other hand, the management system 8 previously issues content IDs indicative of a plurality of sets of contents to be issued in a fixed period and decryption keys corresponding to the plurality of respective sets of contents, records them in the recording device 20, issues data in which the plurality of contents IDs are associated with a series ID, and records this data in the recording device 20. For example, in regard to a given series and contents included in this series, a series ID and a content ID are associated with each other.

The user terminal 6 submits an acquisition request set in which acquisition requests for respective sets of contents of a series which are issued in a subscription period are put together and discount coupon data to the management system 8. It is to be noted that the plurality of acquisition requests included in the acquisition request set include content IDs of the respective sets of contents which are periodically issued, path IDs and a user ID.

The management system 8 reads relationship data of the series ID and the content IDs in the recording device 20, and judges whether the content ID of each acquisition request included in the acquisition request set is associated with the series ID of the discount coupon data.

Moreover, the management system 8 judges whether the path ID of each acquisition request is equal to the path ID of the discount coupon data.

Additionally, the management system 8 judges whether the number of acquisition requests included in the acquisition request set, i.e., the number of requested decryption keys meets the key number condition of the discount coupon data.

If all the discount conditions are satisfied, the management system 8 charges an amount of money obtained by subtracting a discount amount of the discount coupon data from a sum of fees of the decryption keys requested in bulk, and returns a set of the decryption keys corresponding to the set to the user terminal 6.

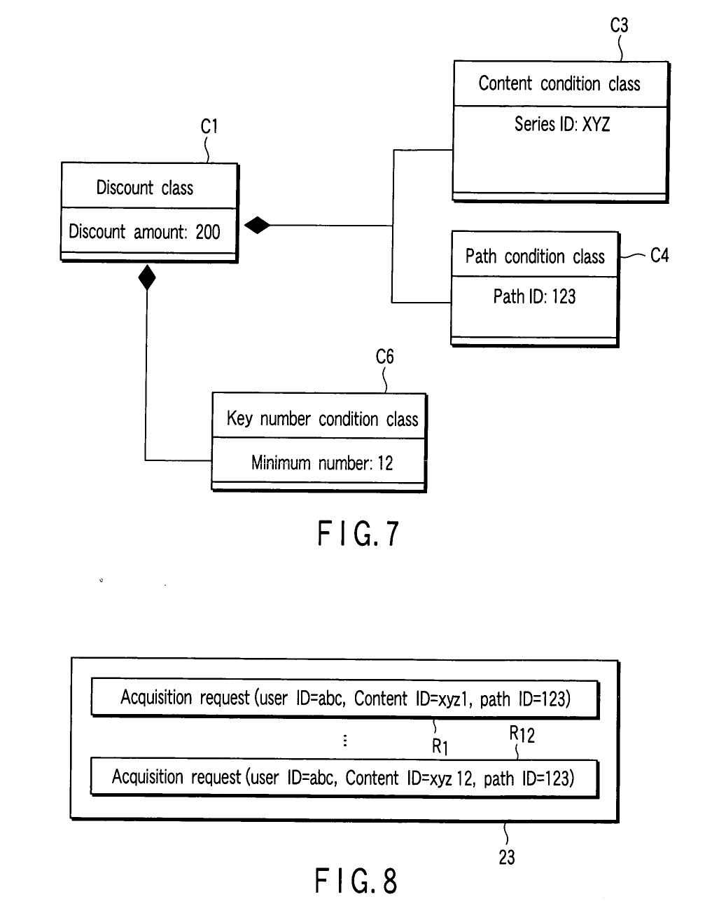

FIG. 7 is a class diagram showing an example of discount data when a plurality of sets of encrypted contents which are periodically issued are acquired through the same circulation path and decryption keys of the respective sets of encrypted contents are previously acquired in bulk.

For example, it is assumed that contents which are issued every month are periodically purchased for one year and a unit price of each set of periodically issued contents is 100 yen. Although a set price is 1200 yen in case of a subscription for one year, it is assumed that a discount of 200 yen is made when acquiring encrypted contents by utilizing a given circulation path.

In this case, as shown in FIG. 7, in discount coupon data, a series ID “XYZ” is defined in the content condition class C3, and a path ID “123” is defined in the path condition class C4. It is to be noted that the series ID indicates a series of periodic contents which are desired to be purchased in this example. Further, since this is a case of purchase for one year, the minimum number “12” is defined in the key number condition class C6.

With this discount coupon data, the user 5 can purchase decryption keys for one year from an arbitrary month and get a discount of 200 yen.

The user 5 previously obtains the discount coupon data shown in FIG. 7 without a fee. In regard to an obtention method, it is possible to obtain this data by exhibiting the user's user ID in a Web site of the contents provider 1 or the content circulator 3. An arbitrary person can freely utilize the discount coupon any number of times.

The user terminal 6 operated by the user 5 who is identified by a user ID “abc” provides the management system 8 with the discount coupon data shown in FIG. 7 and an acquisition request set 23 including such acquisition requests R₁ to R₁₂ as shown in FIG. 8. Respective sets of contents for one year are identified by contents IDs “xyz1” to “xyz12”.

The discount coupon verifying function 10 determines that the series ID “XYZ” defined in the content condition class is consistent with the content IDs “xyz1” to “xyz12” of the respective acquisition requests R₁ to R₁₂, the path ID “123” defined in the path condition class matches with the path ID “123” of the respective acquisition requests R₁ to R₁₂ and the acquisition request set 23 requests “12” or more decryption keys at minimum indicated by the key number condition class, and the service function 11 of the distribution management function 22 asks the charging section 17 for charging of an amount of money obtained by making a discount “200” yen on a list price 1200 yen of the 12 decryption keys.

The communicating function 9 of the distribution management function 22 provides the user terminal 6 with a decryption key set for one year.

It is to be noted that, when a fee paid by the user 5 is distributed between a plurality of persons, e.g., the contents provider 1 or the content circulator 3, the service function 11 asks for charging according to a distribution result.

The user terminal 6 acquires each set of periodically issued encrypted contents from a contractual circulation path every month and takes out a corresponding key from a previously accepted decryption key set, thereby reproducing contents.

### Third Embodiment

In the second embodiment, before accepting the acquisition request set, a decryption key set with respect to periodically issued encrypted contents must be recorded in the recording device 20 of the management system 8 in advance.

On the contrary, in this embodiment, the user 5 performs a contract and settlement of subscription with respect to an issuer of discount coupon data in advance, and acquires the discount coupon data from the issuer of this discount coupon data.

It is to be noted that a user ID of a user who utilizes a decryption key, a series of a content to be purchased, a circulation path of the content and a purchase period are specified in the fixed interval purchasing contract.

Further, the user terminal 6 of the user 5 provides the management system 8 with the previously acquired discount coupon data and a decryption key acquisition request, and acquires a decryption key which has been already created at this point in time in decryption keys with respect to periodically issued encrypted contents.

In this embodiment, the user 5 first specifies his/her user ID, a series of periodically issued contents, a circulation path of contents and a purchase period and requests discount coupon data with respect to a discount coupon data issuer who is one of the content provider 1, the content circulator 3 and the key manager 7.

The discount coupon data issuer issues to the user 5 discount coupon data in which a user ID specified by the user 5, a series ID indicative of the series specified by the user 5, a path ID indicative of a circulation path of contents specified by the user and a purchase period are defined in the user condition class C2, the content condition class C3, the path condition class C4 and the time condition class C5.

The user 5 pays a fee to the discount coupon data issuer.

The user terminal 6 operated by the user 5 provides the management system 8 with a decryption key acquisition request with respect to periodically encrypted contents and discount coupon data in a period defined by a start time and an end time of the discount coupon data.

In this example, the acquisition request includes a user ID, a series ID and a path ID.

The discount coupon verifying function 10 of the management system 8 judges whether the user ID, the series ID and the path ID of the discount coupon data match with the user ID, the series ID and the path ID of the acquisition request and whether the time at which the acquisition request is accepted is within a discount coupon data purchase period.

When the discount conditions are satisfied, the service function 11 of the management system 8 asks the charging section 17 for charging an amount of money obtained by subtracting a discount amount defined in the discount coupon data from a fee of the decryption key.

The communicating function 9 of the distribution management function 22 provides the user terminal 6 with the decryption key corresponding to the acquisition request.

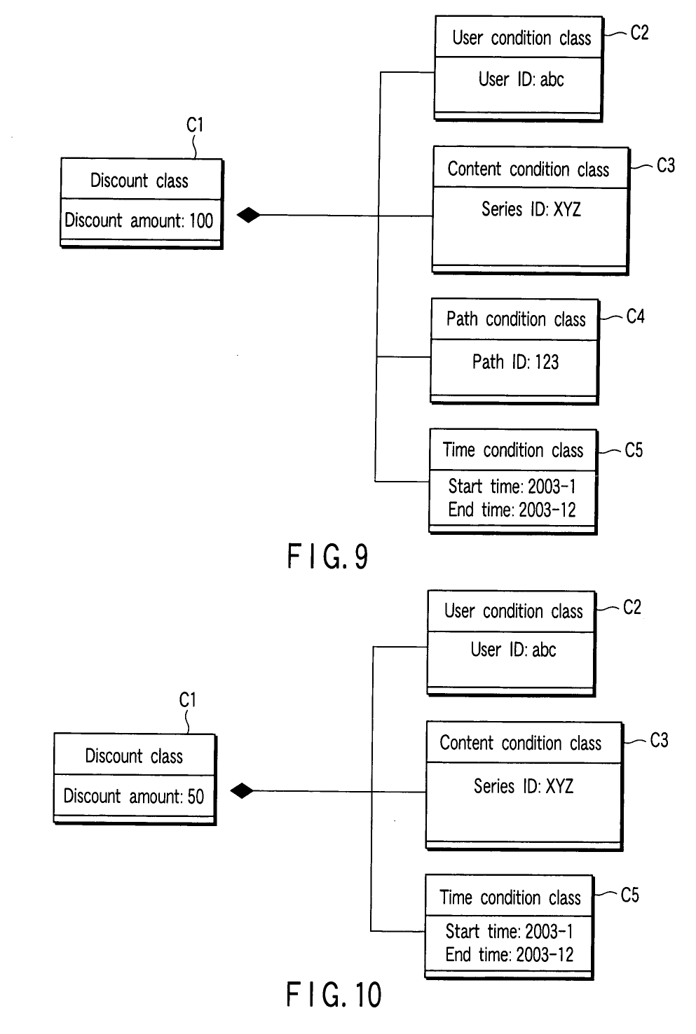

FIG. 9 is a class diagram showing an example of discount data when periodically issued contents are acquired from the same path and a decryption key for each set of encrypted contents which are periodically issued is acquired at an arbitrary timing.

For example, the user 5 specifies a user ID “abc”, a series ID “XYZ”, a path ID “123” and a purchase period “a start time: 2003-1, an end time: 2003-12” and purchases discount coupon data shown in FIG. 9 from a discount coupon data issuer with a fee of 1000 yen. In this discount coupon data, the user ID “abc” is defined as discount conditions, and the user 5 indicated by the specified user ID “abc” alone can utilize this discount coupon data.

This discount coupon data shown in FIG. 9 is different from the discount coupon data of FIG. 7 described in conjunction with the second embodiment in that the time condition class C5 is defined in place of the key number condition class C6, and other parts are the same. Furthermore, in the discount coupon data of FIG. 9, a discount amount “100” is defined.

In this embodiment, a fee of one decryption key for each set of encrypted contents which are periodically issued is determined as 100 yen, and contents of this series are identified by a series ID “XYZ”.

The fee of the decryption key is 100 yen, the discount amount of contents is also 100 yen, and hence the fee and the discount amount are equal to each other. Therefore, by providing this discount coupon data of FIG. 9, the user 5 having the user ID “abc” can acquire a decryption key for each set of encrypted contents which is identified by the series ID “XYZ” and usually costs 100 yen any number of times without a fee in a period from January to December in 2003.

As described above, in this embodiment, the user 5 purchases the discount coupon data, acquires each set of periodically issued encrypted contents in a determined distribution path every period after purchasing, and utilizes this discount coupon data to acquire a decryption key corresponding to each set of encrypted contents without a fee.

As a result, the user 5 can acquire 12 sets of periodic contents each of which costs 100 yen without a fee by just paying 1000 yen which is a fee for the discount data, and hence can get a discount of 200 yen.

However, since the user 5 has made a contract under the conditions of acquiring encrypted contents from a specific circulation path and acquired the discount coupon data, this discount coupon data cannot be used with respect to a content obtained from another circulation path.

In this embodiment, all decryption keys of a series do not have to be previously recorded in the recording device 20 of the management system 8, and it is good enough to record a decryption key corresponding to an acquisition request when this acquisition request for each set of contents belonging to the series is accepted.

Further, by preparing a series ID, a content ID which identifies each set of contents included in the series does not have to be previously set.

### Fourth Embodiment

In the second and third embodiments, a circulation path for periodically issued encrypted contents must be determined in advance.

On the contrary, in this embodiment, a description will be given as to a discount service when purchasing a decryption key for periodically issued encrypted contents without specifying a circulation path.

The user 5 does not specify a circulation path when requesting issue of discount coupon data. A discount coupon data issuer issues discount coupon data in which a path ID is not defined to the user 5.

As a result, it is possible to perform charging with a discount amount subtracting from a fee paid to the content provider 1.

That is, in this embodiment, the user 5 pays a regular fee to the content circulator 3 passed until an encrypted content is acquired, and pays a discounted fee a discount to the content provider 1.

Therefore, the management system 8 does not judge the consistency about the path ID between a decryption key acquisition request and the discount coupon data.

FIG. 10 is a class diagram showing an example of discount data when acquiring periodically issued encrypted contents through an arbitrary path and making a discount on a fee which is paid to the content provider 1.

For example, it is assumed that a fee of a decryption key with respect to each set of encrypted contents of a periodically issued series is distributed and the content provider 1 takes 50 yen. Furthermore, it is assumed that 12 sets of contents of this series are issued in one year and an annual fee before a discount which is paid to the content provider 1 from the user 5 is 600 yen. Moreover, in case of periodic ordering, a regular fee 600 yen which is paid to the content provider 1 from the user 5 in one year is reduced to 480 yen.

In FIG. 10, the path condition class C4 is eliminated with respect to the discount coupon data of FIG. 9 which has been described in conjunction with the third embodiment.

Additionally, in FIG. 10, an amount of fee “50” which is taken by the content provider 1 is defined as a discount amount when a fee of one decryption key is distributed.

The user 5 having a user ID “abc” pays a discounted fee 480 yen which is paid to the content provider 1 to acquire the discount coupon data in advance. The user terminal 6 operated by the user 5 provides the management system 8 with this discount coupon data and an acquisition request every period.

Assuming that a fee of a decryption key of encrypted contents obtained through an arbitrary distribution path is 120 yen, the management system 8 charges a balance amount 70 from a discount amount 50 as a fee with respect to the content circulator 3.

The user 5 subtracts 50 yen which is taken by the content provider 1 from the regular fee with respect to each decryption key for contents of the series by using this discount coupon data in a specified subscription period, pays a fee with respect to the content circulator 3, and acquires a decryption key with respect to encrypted contents of the series.

In this embodiment, the user 5 pays the fee after a subscription discount of the content provider 1 to acquire the discount coupon data, acquires encrypted contents of the series through an arbitrary circulation path, acquires each decryption key for each set of encrypted contents, and pays a fee for the content circulator 3 who has appeared in the discount circulation path. It is to be noted that a commission of a key management center or a settlement organization as well as the contents circulation 3 may be paid as a fee in some cases.

As a result, a discount based on periodic ordering can be made with respect to a fee paid to the content provider 1 even if a circulation path is not specified.

### Fifth Embodiment

In this embodiment, a description will be given as to the setting of conditions of discount coupon data which realizes a discount service based on group purchasing by the content distribution system described in conjunction with the first embodiment.

In this embodiment, decryption keys for individuals in a group are acquired in bulk. A state of acquisition of decryption keys according to this embodiment is similar to the second embodiment in that a plurality of decryption keys are acquired in bulk.

In this embodiment, the user 5 acquires discount coupon data in which a content ID is defined in the content condition ID class C3, a path ID is defined in the path condition ID class C4 and a minimum head count is defined in the head count condition class C7 in advance from one of the content provider 1, the content circulator 3, the key manager 7 and other users.

The user terminal 6 operated by the user 5 who has acquired the discount coupon data provides the management system 8 with an acquisition request set together with the discount coupon data. Each acquisition request included in the acquisition request set includes a user ID of each user belonging to the group, a content ID and a path ID.

The management system 8 judges whether the content ID and the path ID of each acquisition request included in the acquisition request set matches with the content ID and the path ID defined in the discount coupon data and whether the number of the user IDs of the acquisition requests included in the acquisition request set satisfies the head count condition of the discount coupon data.

When the discount conditions are satisfied, the management system 8 charges an amount obtained by subtracting a discount amount defined in the discount coupon data from a sum total of fees for decryption keys requested in bulk, and returns the requested decryption key set to the user terminal 6.

When an arbitrary person in the group acquires decryption keys corresponding to the number of persons and distributes the decryption keys to the members in the group, it is determined that each decryption key includes information of a user ID of a user who can utilize this decryption key, a path ID and a content ID. The information included in the decryption key is subjected to interpolation prevention processing.

The decryption key must be able to be used by a specific user or user terminal. Therefore, for example, the management system 8 applies a signature or encryption to the decryption key, and the user terminal verifies that interpolation is not made to the decryption key.

The user terminal may be able to execute a proper program only which has tamper-resistant properties and performs processing in accordance with a predetermined rule. Further, encryption inherent to a user ID may be carried out to a decryption key so that a predetermined user terminal alone can decrypt the encrypted decryption key.

It is to be noted that a decryption key must be able to be used with respect to a specific encrypted content alone. However, since the decryption key corresponds to the specific encrypted content, special processing does not have be to performed in particular.

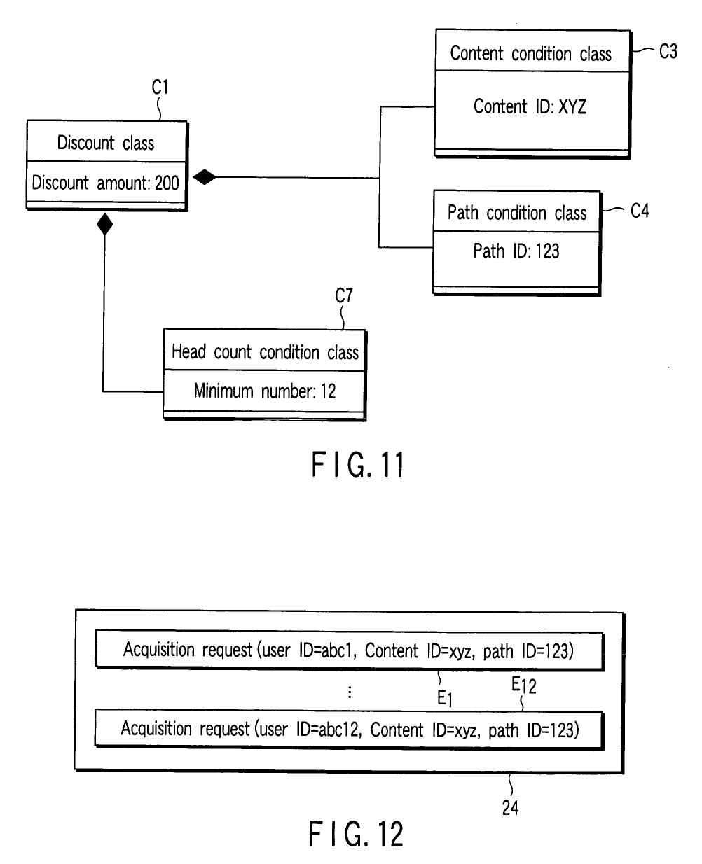

FIG. 11 is a class diagram showing an example of discount coupon data when purchasing decryption keys by a group in bulk.

For example, it is assumed that, when contents whose unit price is 100 yen is purchased by 12 people, 200 yen is subtracted from a total amount 1200 yen.

In this case, as shown in FIG. 11, a content ID “XYZ” is defined in the content condition class C3 and a path ID “123” is defined in the path condition class C4 in the discount coupon data. Furthermore, in order to apply a discount when purchasing contents by 12 or more people in bulk, the minimum head count “12” is defined in the head count condition class C7.

With this discount coupon data, the user 5 who wants acquisition of decryption keys for the members in the group can purchase the decryption keys for 12 people with a discount of 200 yen.

First, the user 5 previously obtains the discount coupon data of FIG. 11 without a fee. The obtention method is the same as that of the first embodiment.

The user terminal 6 operated by the user 5 provides the management system 8 with the discount coupon data of FIG. 11 and an acquisition request set including such acquisition requests E₁ to E₁₂ as shown in FIG. 12.

Users who are identified by user IDs “abc1” to “abc12” belong to the group. Further, an encrypted content of a content identified by a contents ID “xyz” is acquired through a path identified by a path ID “123”.

The discount coupon verifying function 10 of the management system 8 determines that the discount conditions indicated by the discount coupon data are consistent with the acquisition request set. Therefore, the service function 11 of the management system 8 asks the charging section 17 for charging of a discounted fee obtained by reducing 200 yen from a fee 1200 yen of the decryption keys for 12 people.

It is to be noted that, when the fee paid by the user 5 is distributed between a plurality of persons, e.g., the content provider 1, the content circulator 3 or the like, the service function 11 asks for changing based on a distribution result.

The user terminal 6 of the user 5 which has requested the decryption keys for the members in the group can acquire the decryption keys for 12 people with the discount service.

It is to be noted that user terminals which can respectively use the acquired 12 decryption keys are determined, and the user terminal 6 which has accepted the decryption keys from the management system 8 provides the corresponding user terminals with the individual decryption keys. It is to be noted that an encrypted content itself may be copied and shared in the group.

### Sixth Embodiment

In the fifth embodiment, any user belonging to the group must acquire the decryption keys for all members and distribute these keys to the members in the group.

On the contrary, in this embodiment, a description will be given as to a discount service when discount coupon data is distributed to members in place of decryption keys in group purchasing and each member himself/herself acquires a decryption key.

In this embodiment, the user 5 first specifies a user group to which the user himself/herself belongs, a content and a circulation path and requests a discount coupon data issuer who is one of the content provider 1, the content circulator 3 and the key manger 7 for discount coupon data.

The discount coupon data issuer issues discount coupon data to the user, the discount coupon data having a user group ID indicative of the user group specified by the user 5, a content ID indicative of a content and a path ID indicative of the circulation path being defined in the user condition class C2, the content condition class C3 and the path condition class C4.

The user 5 pays a fee to the discount coupon data issuer.

Then, the user 5 copies the discount coupon data, and distributes the data to other users who belong to the user group.

Each user terminal operated by each user who belongs to the user group provides the management system 8 with a decryption key acquisition request and the discount coupon data. In this example, the acquisition request includes the user ID or the user group ID, the content ID and the path ID.

The discount coupon verifying function 10 of the management system 8 judges whether the user group ID, the content ID and the path ID of the discount data are consistent with the user ID or the user group ID, the content ID and the path ID of the acquisition request.

When the discount conditions are satisfied, the service function 11 of the management system 8 asks the charging section 17 for changing an amount obtained by subtracting a discount amount defined in the discount coupon data from a fee of the decryption key. The communicating function 9 of the distribution management function 22 provides the user terminal on the acquisition requesting side with the decryption key corresponding to the acquisition request.

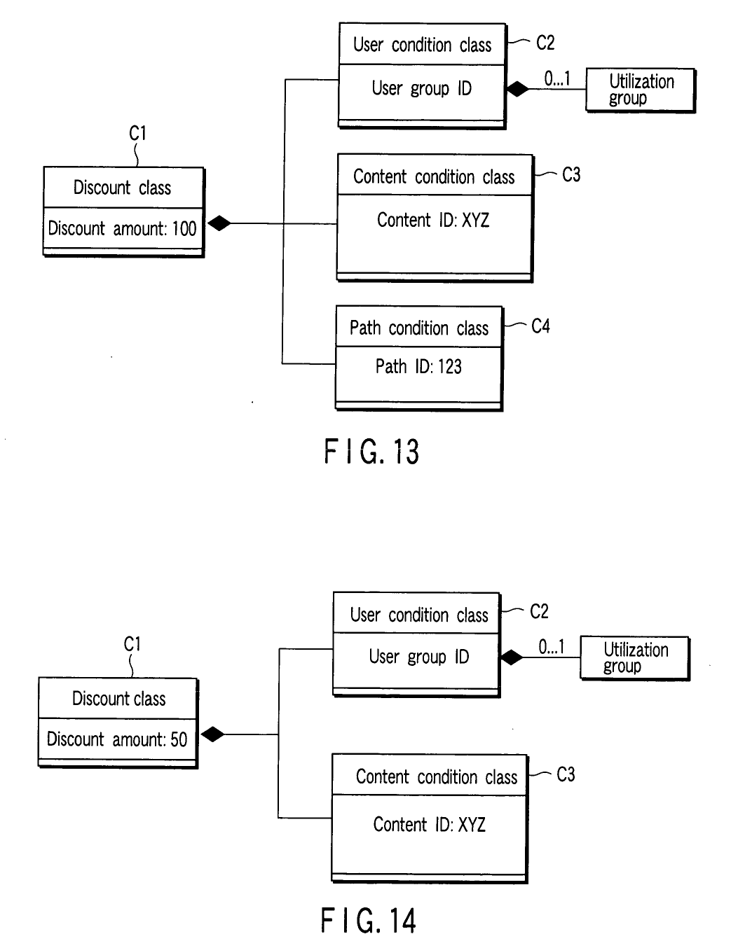

FIG. 13 is a class diagram showing an example of the discount coupon data when each member in the user group acquires a decryption key.

In this FIG. 13, in regard to the discount coupon data of FIG. 11 described in conjunction with the fifth embodiment, the head count condition class C7 is eliminated, and a user group ID which can be used in the user condition class C2 is defined instead.

Furthermore, in FIG. 13, a discount amount is defined as 100 yen.

A user who belongs to the user group acquires a decryption key whose list price is 100 yen for free with this discount coupon data.

The user 5 who is a representative of the user group previously specifies a user group, a content and a path and purchases this discount coupon data for 1000 yen.

After purchasing the discount coupon data, the user 5 copies an encrypted content and the discount coupon data and distributes encrypted contents to members in the user group. Each member transmits the discount coupon data and an acquisition request for a decryption key to the management system 8.

The user group ID is defined in the discount coupon data as a discount condition, and the management system 8 makes a discount with respect to the acquisition request from the user who belongs to this user group. Data in which the user ID of the member in the user group is associated with the user group ID is recorded in the recording device 20 of the management system 8 in advance.

When the discount conditions are satisfied, each member can acquire a decryption key whose list price is 100 yen with a discount of 100 yen, and hence he/she can acquire the decryption key for free.

However, this group purchasing has a contractual coverage that an encrypted content is acquired through a specific circulation path. Therefore, this discount coupon data cannot be used with respect to the encrypted content acquired through a different circulator path.

### Seventh Embodiment

In the fifth and sixth embodiments, a circulator path of an encrypted content must be determined in advance.

On the contrary, in this embodiment, a description will be given as to a discount service which makes a discount with respect to group purchasing without specifying a circulator path.

In this embodiment, each person in a user group can acquire a content from any contents circulator 3, but a discount is applied to a fee with respect to the content provider 1 only, and each user must pay all of a fee with respect to the content circulator 3.

When requesting issue of discount coupon data, the user 5 does not specify a path ID. A discount coupon data issuer who is one of the content provider 1, the content circulator 3 and the key manager 7 issues discount coupon data in which a path ID is not defined to the user 5, and accepts a discounted fee for the content provider 1 from the user 5. As a result, it is possible to perform charging with a discount amount being subtracted from a fee paid to the content provider 1.

That is, in this embodiment, although a regular fee is paid to the content circulator 3 through which the user 5 acquires an encrypted content, a discounted fee is paid to the content provider 1. Therefore, the management system 8 does not verify the detail of the discount coupon data with respect to a path ID included in a decryption key acquisition request.

For example, it is assumed that the content provider 1 takes 50 yen in a list price of a content. Further, it is assumed that 600 yen which is an amount taken by the content provider 1 when 12 people purchase a same content is reduced to 480 yen as a discount for group purchasing.

FIG. 14 is a class diagram showing an example of the discount coupon data when acquiring an encrypted content from an arbitrary circulation path in group purchasing.

In this FIG. 14, in regard to the discount coupon data of FIG. 13 described in conjunction with the sixth embodiment, the path condition class C4 is eliminated, and a discount amount “50” is defined.

The user 5 who is a representative in the user group specifies a user ID of each member in the user group or a recorded user group ID, and pays 480 yen to a discount coupon data issuer to acquire the discount coupon data of FIG. 14. The fee 480 yen of the discount coupon data of FIG. 14 is paid to the content provider.

Then, the user 5 copies the acquired discount coupon data and distributes it to the members.

Each member acquires an encrypted content from a given circulation path. Furthermore, the user terminal operated by each member provides the management system 8 with the discount coupon data and a decryption key acquisition request.

Each member pays an amount obtained by subtracting 50 yen which is a fee for the content provider 1 from a fee of the content in accordance with the discount coupon data and the acquisition request, thereby acquiring a decryption key.

For example, when a fee of a content obtained through a given circulation path is 120 yen, an amount 70 yen obtained by subtracting a discount amount 50 yen from 120 yen is a fee for the contents circulator 3. It is to be noted that a commission for a key management center or a settlement organization as well as the content circulator 3 may be also paid as a fee in some cases.

In this embodiment, the representative of the user group acquires the discount coupon data with a discounted fee paid to the content provider 1. Each member pays a fee to the content circulator in a circulation path for an encrypted content, thereby acquiring a decryption key.

Consequently, in group purchasing, the discount service can be provided irrespective of an encrypted content acquisition path.

Each of the foregoing embodiments can be likewise applied to the case where a person other than the content provider 1, the content circulator 3, the user 5 and the key manager 7 is a distribution participator.

Moreover, each role of the content provider 1, the content circulator 3, the user 5 and the key manager 7 may be fulfilled by the same proprietor or individual, or these roles may be distributed by a plurality of proprietors or individuals. That is, roles and authorities of the distribution participators described in each of the foregoing embodiments can be freely changed.

Additionally, in each of the above-described embodiments, types and formats of contents are arbitrary. As examples of contents, there are image data, electronic book data, music data, moving picture data and others.

### INDUSTRIAL APPLICABILITY

The present invention is utilized in a content circulation field.

1. A privilege management system comprising:
an accepting section which accepts privilege coupon data indicative of a content of a privilege and a condition under which the privilege is granted, and a right data acquisition request including data which is used to judge whether the privilege is granted, from a requesting side of right data which releases a utilization restriction of a circulation content;
a verifying section which judges whether the privilege is granted to the requesting side based on the privilege coupon data and the acquisition request; and
a service section which grants the privilege to the requesting side based on the content of the privilege indicated by the privilege coupon data when it is determined that the privilege is granted,
wherein the privilege coupon data includes a permitting side condition ID which specifies a utilization permitting side which permits granting the privilege,
the acquisition request includes a utilizing side ID indicative of a right data utilizing side, and
the verifying section determines that the privilege is granted to the requesting side when the permitting side condition ID is consistent with the utilizing side ID.

2. The privilege management system according to claim 1, wherein the privilege coupon data further includes utilizing side number condition data which specifies a total number of utilizing sides which permit granting the privilege, and
the verifying section determines that the privilege is granted to the requesting side when the permitting side condition ID is consistent with the utilizing side ID and a total number of the utilizing side IDs included in the acquisition request accepted by the accepting section is not less than the total number of the utilizing sides.

3. The privilege management system according to claim 1, wherein the privilege coupon data further includes a content condition ID which specifies a content group to which a content as a privilege grant target belong to, a path condition ID indicative of a circulation path with which granting the privilege is permitted, and a time condition data which specifies a time in which granting the privilege is permitted,
the acquisition request includes a content ID indicative of the circulation content and a path ID indicative of a circulation path of the circulation content, and
the verifying section determines that the privilege is granted to the requesting side when the permitting side condition ID is consistent with the utilizing side ID, the path condition ID is consistent with the path ID, a time at which the acquisition request is accepted is within a time indicated by the time condition data and the circulation content belong to the content group.

4. The privilege management system according to claim 1, wherein the privilege coupon data further includes a content condition ID which specifies a content group to which a content as a privilege grant target belong and time condition data which specifies a time in which granting the privilege is permitted,
the acquisition request further includes a content ID indicative of the circulation content, and
the verifying section determines that the privilege is granted to the requesting side when the permitting side condition ID is consistent with the utilizing side ID, a time at which the acquisition request is accepted is within a time indicated by the time condition data and the circulation content belong to the content group.

5. The privilege management system according to claim 1, wherein the privilege coupon data further includes reference target data which specifies a reference target, and
the verifying section judges whether the privilege is granted to the requesting side based on data specified by the reference target data included in the privilege coupon data and data included in the acquisition request.

6. The privilege management system according to claim 1, wherein the privilege coupon data is discount coupon data in which a discount amount is a content of the privilege, and
the service section charges the requesting side a discounted fee obtained by subtracting the discount amount from a regular price when it is determined that the privilege is granted.

7. The privilege management system according to claim 6, wherein the discount coupon data includes distribution data indicative of a distribution rule of a fee between a content provider who provides the circulation content and a content circulator who circulates the circulation content, and
the service section distributes the discounted fee to the content provider and the content circulator in accordance with the distribution data.

8. A privilege management system comprising:
an accepting section which accepts privilege coupon data indicative of a content of a privilege and a condition under which the privilege is granted, and a right data acquisition request including data which is used to judge whether the privilege is granted, from a requesting side of right data which releases a utilization restriction of a circulation content;
a verifying section which judges whether the privilege is granted to the requesting side based on the privilege coupon data and the acquisition request; and
a service section which grants the privilege to the requesting side based on the content of the privilege indicated by the privilege coupon data when it is determined that the privilege is granted,
wherein the privilege coupon data includes a content condition ID which specifies a content as a privilege grant target,
the acquisition request includes a contents ID indicative of the circulation content, and
the verifying section determines that the privilege is granted to the requesting side when the content condition ID is consistent with the circulation content ID.

9. The privilege management system according to claim 8, wherein the privilege coupon data further includes a path condition ID which specifies a circulation path with which granting the privilege is permitted and utilizing side number condition data which specifies a total number of utilizing sides which permit granting the privilege,
the acquisition request further includes a utilizing side ID indicative of the right data utilizing side and a path ID indicative of a circulation path of the circulation content, and
the verifying section determines that the privilege is granted to the requesting side when the content condition ID is consistent with the circulation content ID, the path condition ID is consistent with the path ID and a total number of the utilizing side IDs included in the acquisition request accepted by the accepting section is not less than the total number of the utilizing sides.

10. The privilege management system according to claim 8, wherein the privilege coupon data further includes a permitting side condition ID which specifies a utilization permitting side group to which a utilization permitting side which permits granting the privilege belongs,
the acquisition request further includes a utilizing side ID indicative of a right data utilizing side, and
the verifying section determines that the privilege is granted to the requesting side when the content condition ID is consistent with the circulation content ID and the utilizing side belongs to the utilization permitting side group.

11. The privilege management system according to claim 10, wherein the privilege coupon data further includes a path condition ID which specifies a circulation path with which granting the privilege is permitted,
the acquisition request further includes a path ID indicative of a circulation path of the circulation content, and
the verifying section determines that the privilege is granted to the requesting side when the content condition ID is consistent with the circulation content ID, the utilizing side belongs to the utilization permitting side group and the path condition ID is consistent with the path ID.

12. A privilege management system comprising:
an accepting section which accepts privilege coupon data indicative of a content of a privilege and a condition under which the privilege is granted, and a right data acquisition request from a requesting side of right data which releases a utilization restriction of a circulation content;
a verifying section which judges whether the privilege is granted to the requesting side based on the privilege coupon data and the acquisition request; and
a service section which grants the privilege to the requesting side based on the content of the privilege indicated by the privilege coupon data when it is determined that the privilege is granted,
wherein the privilege coupon data includes request number condition data which specifies a total number of requests which permit granting the privilege, and
the verifying section determines that the privilege is granted to the requesting sides when a total number of the acquisition requests accepted by the accepting section is not less than the total number of requests.

13. A privilege management system comprising:
an accepting section which accepts privilege coupon data indicative of a content of a privilege and a condition under which the privilege is granted, and a right data acquisition request including data which is used to judge whether the privilege is granted, from a requesting side of right data which releases a utilization restriction of a circulation content;
a verifying section which judges whether the privilege is granted to the requesting side based on the privilege coupon data and the acquisition request; and
a service section which grants the privilege to the requesting side based on the content of the privilege indicated by the privilege coupon data when it is determined that the privilege is granted,
wherein the privilege coupon data includes a path condition ID which specifies a circulation path with which granting the privilege is permitted,
the acquisition request includes a path ID indicative of a circulation path of the circulation content, and
the verifying section determines that the privilege is granted to the requesting side when the path condition ID is consistent with the path ID.

14. The privilege management system according to claim 13, wherein the privilege coupon data further includes a content condition ID which specifies a content group to which a content as a privilege grant target belong and request number condition data which specifies a total number of requests which permit granting the privilege,
the acquisition request further includes a content ID indicative of the circulation content, and
the verifying section determines that the privilege is granted to the requesting side when the path condition ID is consistent with the path ID, the circulation content belong to the content group and a total number of the acquisition requests accepted by the accepting section is not less than the total number of requests.

15. A privilege management system comprising:
an accepting section which accepts privilege coupon data indicative of a content of a privilege and a condition under which the privilege is granted, and a right data acquisition request from a requesting side of right data which releases a utilization restriction of a circulation content;
a verifying section which judges whether the privilege is granted to the requesting side based on the privilege coupon data and the acquisition request; and
a service section which grants the privilege to the requesting side based on the content of the privilege indicated by the privilege coupon data when it is determined that the privilege is granted,
wherein the privilege coupon data includes time condition data which specifies a time in which granting the privilege is permitted, and
the verifying section determines that the privilege is granted to the requesting side when a time at which the acquisition request is accepted is within a time indicated by the time condition data.

16. A privilege management system comprising:
an accepting section which accepts privilege coupon data indicative of a content of a privilege and a condition under which the privilege is granted, and a right data acquisition request from a requesting side of right data which releases a utilization restriction of a circulation content,
a verifying section which judges whether the privilege is granted to the requesting side based on the privilege coupon data and the acquisition request; and
a service section which grants the privilege to the requesting side based on the content of the privilege indicated by the privilege coupon data when it is determined that the privilege is granted,
wherein the privilege coupon data is subjected to preprocessing in order to detect an interpolation,
the verifying section checks whether the privilege coupon data is interpolated, and
the service section grants the privilege to the requesting side when the privilege coupon data is not interpolated.

17. A method of granting a privilege to a requesting side of right data which releases a utilization restriction of a circulation content by a computer,
the method comprising:
accepting from the requesting side privilege coupon data indicative of a content of the privilege and a condition under which the privilege is granted, and a right data acquisition request including data which is used to judge whether the privilege is granted;
judging whether the privilege is granted to the requesting side based on the privilege coupon data and the acquisition request; and
executing a service which grants the privilege to the requesting side based on the content of the privilege indicated by the privilege coupon data when it is determined that the privilege is granted,
wherein the privilege coupon data includes a permitting side condition ID which specifies a utilization permitting side which permits granting the privilege,
the acquisition request includes a utilizing side ID indicative of a utilizing side of the right data, and
the service is executed when the permitting side condition ID is consistent with the utilizing side ID.

18. A computer-readable recording medium having a program recorded therein,
the program allowing the computer to function as:
an accepting section which accepts privilege coupon data indicative of a content of a privilege and a condition under which the privilege is granted, and a right data acquisition request including data which is used to judge whether the privilege is granted, from a requesting side of right data which releases a utilization restriction of a circulation content;
a verifying section which judges whether the privilege is granted to the requesting side based on the privilege coupon data and the acquisition request; and
a service section which grants the privilege to the requesting side based on the content of the privilege indicated by the privilege coupon data when it is determined that the privilege is granted,
wherein the privilege coupon data includes a permitting side condition ID which specifies a utilization permitting side which permits granting the privilege,
the acquisition request includes a utilizing side ID indicative of a right data utilizing side, and
the verifying section determines that the privilege is granted to the requesting side when the permitting side condition ID is consistent with the utilizing side ID.
